(19) United States
(12) Patent Application Publication
(10) Pub. No.: US 2025/0146248 A1
(43) Pub. Date: May 8, 2025

(54) HYDRAULIC SYSTEM FOR A WORK VEHICLE WITH VALVE ASSEMBLY INCORPORATING A BYPASS LINE

(71) Applicant: CNH Industrial America LLC, New Holland, PA (US)

(72) Inventors: Jonathan Lacher, Fargo, ND (US); Scott Michael Timken, Wichita, KS (US)

(21) Appl. No.: 18/940,118

(22) Filed: Nov. 7, 2024

Related U.S. Application Data
(60) Provisional application No. 63/596,793, filed on Nov. 7, 2023.

(51) Int. Cl. E02F 3/42; E02F 3/34; E02F 9/22; F15B 13/02; F15B 13/06

(52) U.S. Cl. CPC E02F 3/422; E02F 3/3414; E02F 9/2203; F15B 13/027; F15B 13/06; E02F 9/2285; E02F 9/2292; E02F 9/2296

(57) ABSTRACT

In one aspect, a hydraulic system for a work vehicle includes a valve assembly that incorporates a bypass line for allowing pressurized fluid to bypass a valve of the valve assembly and be delivered to a separate downstream valve.

### CROSS-REFERENCE TO RELATED APPLICATIONS

The present application is based upon and claims the right of priority to U.S. Provisional Patent Application No. 63/596,793, filed Nov. 7, 2023, the disclosure of which is hereby incorporated by reference herein in its entirety for all purposes.

### FIELD OF THE INVENTION

The present subject matter relates generally to hydraulic systems for work vehicles and, more particularly, to a hydraulic system for a work vehicle having a valve assembly that incorporates a bypass line for allowing pressurized fluid to bypass a valve of the valve assembly and be delivered to a separate downstream valve.

### BACKGROUND OF THE INVENTION

Work vehicles having lift assemblies, such as skid steer loaders, telescopic handlers, wheel loaders, backhoe loaders, forklifts, compact track loaders and the like, are a mainstay of construction work and industry. For example, skid steer loaders typically include a lift assembly having a pair of loader arms pivotally coupled to the vehicle's chassis that can be raised and lowered at the operator's command. In addition, the lift assembly includes an implement attached to the ends of the loader arms, thereby allowing the implement to be moved relative to the ground as the loader arms are raised and lowered. For example, a bucket is often coupled to the loader arms, which allows the skid steer loader to be used to carry supplies or particulate matter, such as gravel, sand, or dirt, around a worksite.

The lift assembly of the work vehicle is typically controlled via a hydraulic system including a valve assembly for regulating the supply of pressurized hydraulic fluid to the various hydraulic cylinders of the vehicle. For instance, the valve assembly may be configured to regulate the supply of pressurized hydraulic fluid to both a lift cylinder(s) controlling the movement of the loader arms and a tilt cylinder(s) controlling the movement of the implement. In addition, the hydraulic system will often include an accommodation for auxiliary attachments, in which case the valve assembly may also be configured to regulate the supply of pressurized hydraulic fluid to the auxiliary components fluidly coupled thereto.

In this regard, numerous valve assembly and hydraulic system configurations have been proposed in the past for regulating the supply of hydraulic fluid to the various hydraulic components of a work vehicle. However, improvements and/or refinements in such valve assemblies and/or hydraulic systems are still needed to provide improved overall performance. For instance, with currently known valve assemblies and/or hydraulic systems, certain working conditions may exist in which the assembly/system is incapable of satisfying the commanded hydraulic demand for one or more of the hydraulic components of the work vehicle, particularly when the operator is commanding simultaneous actuation of the lift or tilt cylinders in combination with actuation of an auxiliary attachment.

Accordingly, an improved hydraulic system (and related valve assembly) would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a hydraulic system configured in accordance with one or more of the embodiments described herein.

In another aspect, the present subject matter is directed to a valve assembly configured in accordance with one or more of the embodiments described herein.

In a further aspect, the present subject matter is directed to a work vehicle configured in accordance with one or more of the embodiments described herein.

In one aspect, the present subject matter is directed to a hydraulic system for a work vehicle. The hydraulic system includes a pump and a valve assembly fluidly coupled to the pump. The valve assembly includes a first supply line configured to receive pressurized hydraulic fluid from the pump and a first valve fluidly coupled to the first supply line. The first valve is configured to control operation of a first hydraulic component of the work vehicle and has an unactuated position at which the pressurized hydraulic fluid received from the first supply line passes through the first valve to a downstream second supply line. The valve assembly also includes a second valve fluidly coupled to the second supply line. The second valve is configured to control operation of a second hydraulic component of the work vehicle and has an unactuated position at which the pressurized hydraulic fluid received from the second supply line passes through the second valve to a downstream third supply line. In addition, the valve assembly includes a third valve fluidly coupled to the third supply line that is configured to control operation of a third hydraulic component of the work vehicle. The first valve is configured to regulate a supply of the pressurized hydraulic fluid to the first hydraulic component and to receive return fluid from the first hydraulic component, with the return fluid being supplied through the second supply line fluidly coupling the first valve to the second valve. A bypass line provides a path for the pressurized hydraulic fluid flowing through the second supply line to bypass the second valve and be diverted to the third valve. The second valve includes an inlet port fluidly coupled to the second supply line via a second bridge line, and the third valve includes an inlet port fluidly coupled to the third supply line via a third bridge line, with a check valve being provided in association with each of the second bridge line and the third bridge line. Moreover, a first end of the bypass line is connected to the second bridge line upstream of the check valve associated with the second bridge line, and a second end of the bypass line is connected to the third bridge line downstream of the check valve associated with the third bridge line.

In another aspect, the present subject matter is directed to a work vehicle. The work vehicle includes a lift assembly comprising at least one loader arm and an implement coupled to the at least one loader arm. The work vehicle also includes a lift cylinder configured to control movement of the at least one loader arm, a tilt cylinder configured to control movement of the implement, and a hydraulic system fluidly coupled to the lift and tilt cylinders. The hydraulic system includes a pump and a valve assembly fluidly coupled to the pump. The valve assembly includes a first supply line configured to receive pressurized hydraulic fluid from the pump and a first valve fluidly coupled to the first supply line. The first valve is configured to control operation of the lift cylinder and has an unactuated position at which the pressurized hydraulic fluid received from the first supply line passes through the first valve to a downstream second supply line. The valve assembly also includes a second valve fluidly coupled to the second supply line. The second valve is configured to control operation of the tilt cylinder and has an unactuated position at which the pressurized hydraulic fluid received from the second supply line passes through the second valve to a downstream third supply line. In addition, the valve assembly includes a third valve fluidly coupled to the third supply line that is configured to control operation of an auxiliary attachment of the work vehicle. The first valve is configured to regulate a supply of the pressurized hydraulic fluid to the lift cylinder and to receive return fluid from the lift cylinder, with the return fluid being supplied through the second supply line fluidly coupling the first valve to the second valve. Moreover, a bypass line is fluidly coupled to the second supply line to provide a path for the pressurized hydraulic fluid flowing through the second supply line to bypass the second valve and be diverted to the third valve.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of a work vehicle in accordance with aspects of the present subject matter;

FIG. 2 illustrates a schematic view of various components of the work vehicle shown in FIG. 1, particularly illustrating one embodiment of a hydrostatic transmission of the work vehicle in accordance with aspects of the present subject matter;

FIG. 3 illustrates a schematic view of one embodiment of a hydraulic system for controlling various hydraulic components of a work vehicle in accordance with aspects of the present subject matter; and

FIG. 4 illustrates a schematic view of a valve assembly of the hydraulic system shown in FIG. 3, particularly illustrating the valve assembly incorporating a bypass line to provide an alternative path for supplying pressurized hydraulic fluid to the downstream auxiliary spool/valve.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to improved hydraulic systems and related valve assembly for controlling the operation of hydraulically-driven components of a work vehicle. Specifically, in several embodiments, the disclosed valve assembly incorporates a bypass line that allows pressurized fluid to bypass or be diverted around one valve of the valve assembly and be delivered to a separate downstream valve of the valve assembly. For instance, as will be described below, the valve assembly may include separate spools or valves for regulating the supply of pressurized hydraulic fluid to the vehicle's lift assembly (e.g., lift and tilt valves) and another spool or valve for regulating the supply of pressurized hydraulic fluid to an auxiliary attachment of the work vehicle. In one embodiment, the lift valve may be provided upstream of the tilt and auxiliary valves, with the pressurized fluid supplied to the lift valve being directed downstream to the tilt and auxiliary valves. In this regard, with the tilt valve being located immediately downstream of the lift valve, the bypass line is provided to create a parallel path for pressurized fluid flowing from the lift valve to be directed to both the tilt valve and the auxiliary valve. In the absence of such bypass line, the amount of pressurized hydraulic fluid available to the auxiliary valve during actuation of the tilt valve would be limited significantly, thereby preventing or impacting operation of the related auxiliary attachment.

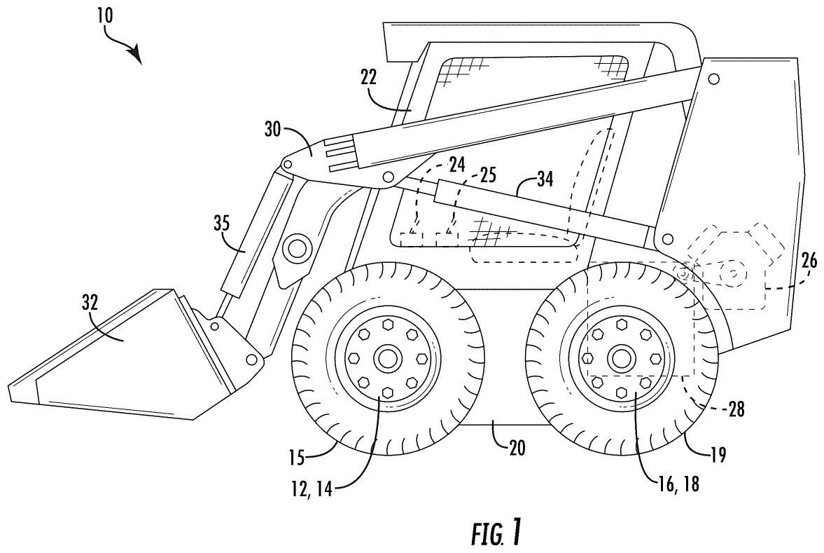

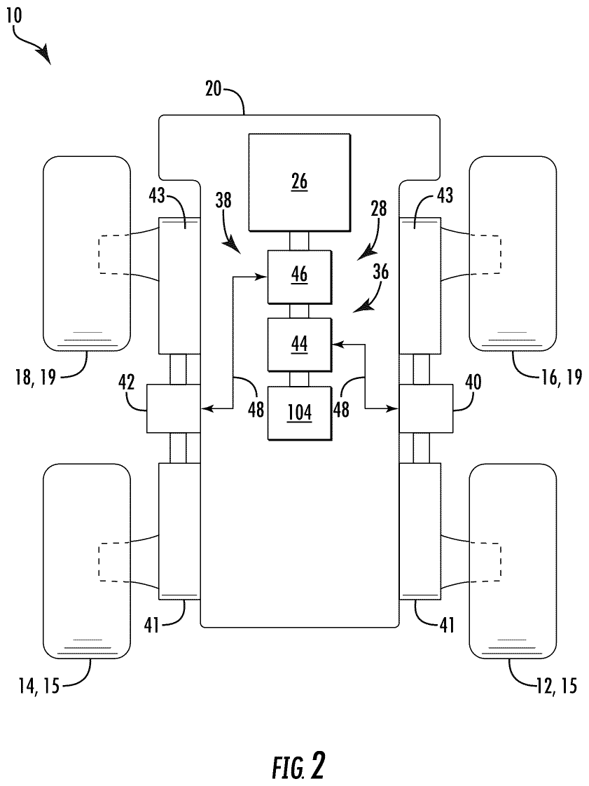

Referring now to the drawings, FIGS. 1 and 2 illustrate different views of one embodiment of a work vehicle 10. Specifically, FIG. 1 illustrates a side view of the work vehicle 10 and FIG. 2 illustrates a schematic view of various components of the work vehicle 10 shown in FIG. 1. As shown, the work vehicle 10 is configured as a skid steer loader. However, in other embodiments, the work vehicle 10 may be configured as any other suitable work vehicle known in the art that includes a hydraulically driven lift assembly and/or other similar hydraulic functions.

As shown, the work vehicle 10 includes a pair of front wheels 12, 14 (and associated front tires 15), a pair of rear wheels 16, 18 (and associated rear tires 19), and a chassis 20 coupled to and supported by the wheels 12, 14, 16, 18. An operator's cab 22 may be supported by a portion of the chassis 20 and may house various input devices, such as one or more speed/steering control levers or joysticks 24 and one or more lift/tilt levers or joysticks 25, for permitting an operator to control the operation of the work vehicle 10. In addition, the work vehicle 10 may include an engine 26 and a dual-path hydrostatic transmission 28 coupled to or otherwise supported by the chassis 20.

Moreover, as shown in FIG. 1, the work vehicle 10 may include a lift assembly having a pair of loader arms 30 (one of which is shown) coupled between the chassis 20 and a suitable implement 32 (e.g., a bucket, fork, blade and/or the like). Hydraulic cylinders 34, 35 may also be coupled between the chassis 20 and the loader arms 30 and between the loader arms 30 and the implement 32 to allow the implement 32 to be raised/lowered and/or pivoted relative to the ground. For example, one or more lift cylinders 34 may be coupled between the chassis 20 and each loader arm 30 for raising and lowering the loader arms 30, thereby controlling the height of the implement 32 relative to the ground. Additionally, one or more tilt cylinders 35 may be coupled between each loader arm 30 and the implement 32 for pivoting the implement 32 relative to the loader arms 30, thereby controlling the tilt or pivot angle of the implement 32 relative to the ground.

As particularly shown in FIG. 2, the hydrostatic drive unit 28 of the work vehicle 10 may include a pair of independently controlled hydraulic drive systems (e.g., a first or left-side drive system 36 and a second or right-side drive system 38), with each drive system 36, 38 being configured to separately drive either the left-side 12, 16 or the right-side wheels 14, 18 of the work vehicle 10 via an associated hydraulic pump/motor. For example, as shown in the illustrated embodiment, the left-side drive system 36 includes a first or left hydraulic motor 40 configured to drive the left-side wheels 12, 16 via front and rear axles 41, 43, respectively, while the right-side drive system 38 includes a second or right hydraulic motor 42 configured to drive the right-side wheels 14, 18 via front and rear axles 41, 43, respectively. Alternatively, the motors 40, 42 may be configured to drive the wheels 12, 14, 16, 18 using any other suitable means known in the art, such as by coupling each motor 40, 42 to its respective pair of wheels via a suitable sprocket/chain arrangement (not shown). Additionally, each drive system 36, 38 may also include a separate hydraulic pump driven by the engine 26, which, in turn, supplies pressurized fluid to its respective motor. For example, in the illustrated embodiment, the left-side drive system 36 includes a first or left hydraulic pump 44 fluidly connected to the left motor 40 (e.g., via a suitable hydraulic hose or other fluid coupling 48) while the right-side drive system 38 includes a second or right hydraulic pump 46 fluidly connected to the right motor 40 (e.g., via a suitable hydraulic hose or other fluid coupling 48).

In the illustrated embodiment, by individually controlling the operation of each pump 44, 46, the speed of the left-side wheels 12, 16 may be regulated independent of the right-side wheels 14, 18. For example, each pump 44, 46 may include or be associated with one or more electronically controlled actuators (e.g., forward and reverse solenoids coupled to a control piston) configured to adjust the position of its associated swashplate, thereby allowing the displacement of the pump 44, 46 to be automatically adjusted. As such, by adjusting the displacement of the left pump 44, the flow of the hydraulic fluid supplied to the left motor 40 may be varied, thereby adjusting the output speed of the motor 40 and, thus, the associated drive speed of the left-side wheels 12, 16. Similarly, by adjusting the displacement of the right pump 46, the flow of the hydraulic fluid supplied to the right motor 42 may be varied, thereby adjusting the output speed of the motor 42 and, thus, the associated drive speed of the right-side wheels 14, 18.

It should be appreciated that the configuration of the work vehicle 10 described above and shown in FIGS. 1 and 2 is provided only to place the present subject matter in an exemplary field of use. Thus, it should be appreciated that the present subject matter may be readily adaptable to any manner of work vehicle configuration. For example, in an alternative embodiment, the work vehicle 10 may be configured as a tracked vehicle and, thus, may include tracks as opposed to wheels/tires. In such an embodiment, each motor 40, 42 may be configured to rotationally drive an associated drive wheel of the tracked vehicle that, in turn, is coupled to and drives an endless track. Accordingly, it should be appreciated that any suitable drive output component(s) (including wheels/tires or a drive wheel/track) may be included within or otherwise associated with each of the left-side and right-side drive systems 36, 38 for propelling and/or steering the work vehicle 10.

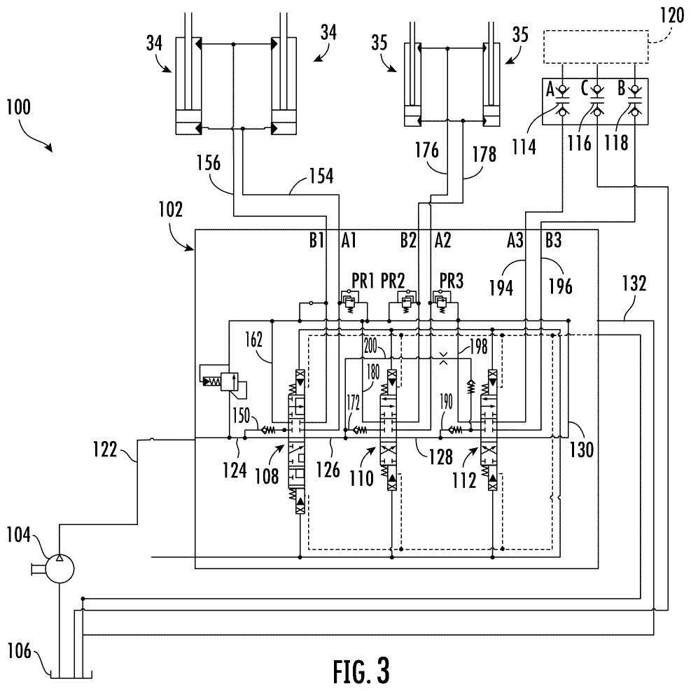

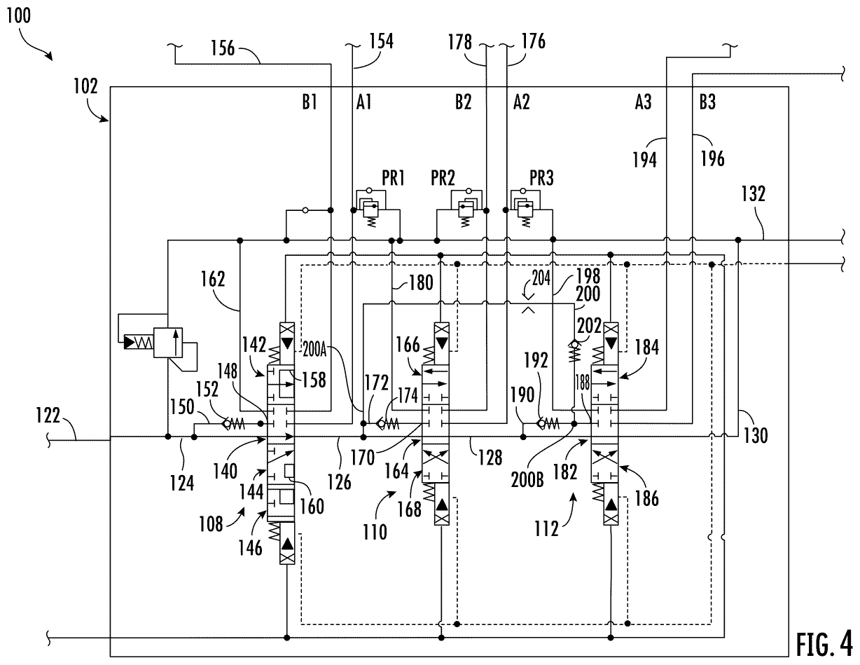

Referring now to FIGS. 3 and 4, schematic views of one embodiment of a hydraulic system 100 suitable for use with a work vehicle is illustrated in accordance with aspects of the present subject matter. Specifically, FIG. 3 illustrates a general schematic view of the hydraulic system 100, while FIG. 4 illustrates a zoomed-in or enlarged view of a valve assembly 102 of the hydraulic system 100 shown in FIG. 3. In general, the hydraulic system 100 will be described herein with reference to the work vehicle 10 described above with reference to FIGS. 1 and 2. However, it should be appreciated by those of ordinary skill in the art that the disclosed hydraulic system 100 may generally be utilized to control the hydraulically-driven components of any suitable work vehicle.

As shown in FIG. 3, the hydraulic system 100 generally includes a pump 104 for supplying pressurized hydraulic fluid (e.g., from a source tank 106) to an associated valve assembly (as indicated by box 102 in FIGS. 3 and 4), with the valve assembly 102 being configured to control the operation of various hydraulic components of the work vehicle 10. For instance, the valve assembly 102 includes a lift valve or spool (hereinafter referred to as the “first valve 108”) for controlling the operation of the lift cylinders 34 of the work vehicle 10 and a tilt valve or spool (hereinafter referred to as the “second valve 110”) for controlling the operation of the tilt cylinders 35 of the work vehicle 10. In addition, the valve assembly 102 includes an auxiliary valve or spool (hereinafter referred to as the “third valve 112”) for controlling the operation of any number of auxiliary attachments or hydraulically-driven components configured to be coupled to the work vehicle's auxiliary outputs or couplers 114, 116, 118. For instance, as shown in FIG. 3, a hydraulic actuator 120 (e.g., a hydraulic motor, hydraulic cylinder, or the like) is schematically shown as being coupled to the vehicle's auxiliary couplers 114, 116, 118 to allow the third valve 112 to control the operation of such actuator 120.

As particularly shown in FIG. 4, the valve assembly 102 is configured as an open-center series, parallel valve assembly to allow pressurized hydraulic fluid to be supplied from the pump 104 through the center of each valve 108, 110, 112 when the valves are at their neutral or unactuated positions (e.g., the positions shown in FIG. 4). Thus, at such positions, pressurized hydraulic fluid supplied from the pump 104 to the valve assembly 102 (e.g., via a pump supply line 122) can flow through a first valve supply line 124 to the first valve 108, where the fluid passes through the center of the first valve 108 and flows through a second valve supply line 126 to the second valve 110. The pressurized fluid can then flow through the center of the second valve 110 and be directed through a third valve supply line 128 to the third valve 112, at which point the fluid passes through the center of the third valve 112 and is expelled from an outlet of the valve assembly 102 through a valve outlet line 130 fluidly connected to a main return or tank line 132 of the hydraulic system 100 for delivery back to tank 106.

As shown in FIG. 4, the first valve 108 is configured as a pilot-actuated, four position valve (e.g., a neutral position 140, a first actuated position 142, a second actuated position 144, and a third actuated position 146). As indicated above, at the neutral position 140, the first valve 108 allows pressurized fluid supplied from the pump 104 to pass there-through for delivery to the downstream valve(s). As shown in FIG. 4, in addition to the inlet port associated with the open-center configuration, the first valve 108 also includes an inlet port 148 fluidly coupled to the first valve supply line 124 via a first bridge line 150. The first bridge line 150 provides a fluid connection directly between the first valve supply line 124 and the inlet port 148 of the first valve 108 and incorporates a check valve 152 therewith to prevent back-flow.

At the first actuated position 142 of the first valve 108, pressurized fluid is supplied from the first bridge line 150 through the first valve 108 and is then directed through a lift cap-end line 154 to the cap-ends of the lift cylinders 34. Additionally, at such first actuated position, return fluid flows from the rod-ends of the lift cylinders 34 through a lift rod-end line 156 back to the first valve 108, where the return fluid is looped through a branch line 158 in the first valve 108 to the second valve supply line 126 for delivery to the downstream valve(s). At the second actuated position 144 of the first valve 108, pressurized fluid is supplied from the first bridge line 150 through the first valve 108 and is directed through the lift rod-end line 156 to the rod-ends of the lift cylinders 34. Additionally, at such second actuated position, return fluid flows from the cap-ends of the lift cylinders 34 through the lift cap-end line 154 back to the first valve 108, where the return fluid is looped through a branch line 160 in the valve 108 to the second valve supply line 126 for delivery to the downstream valve(s). Moreover, at the third actuated position 146 of the first valve 108, the valve 108 is provided in a float configuration in which both ends of the lift cylinders 34 are ported to tank 106. Specifically, at the third actuated position 146, both the lift cap-end line 154 and the lift rod-end line 156 are fluidly coupled to a first return line 162 that, in turn, is fluidly coupled to the tank line 132.

Referring still to FIG. 4, the second valve 110 is configured as a pilot-actuated, three position valve (e.g., a neutral position 164, a first actuated position 166, and a second actuated position 168). As indicated above, at the neutral position 164, the second valve 110 allows pressurized fluid to pass there-through for delivery to the downstream valve(s). As shown in FIG. 4, in addition to the inlet port associated with the open-center configuration, the second valve 110 also includes an inlet port 170 fluidly coupled to the second valve supply line 126 via a second bridge line 172. The second bridge line 172 provides a fluid connection directly between the second valve supply line 126 and the inlet port 170 of the second valve 110 and incorporates a check valve 174 therewith to prevent back-flow.

At the first actuated position 166 of the second valve 108, pressurized fluid is supplied from the second bridge line 172 through the second valve 108 and is then directed through a tilt rod-end line 176 to the rod-ends of the tilt cylinders 35. Additionally, at such first actuated position, return fluid flows from the cap-ends of the tilt cylinders 35 through a tilt cap-end line 178 back to the second valve 110, where the return fluid is then directed to a second return line 180 that fluidly couples to the tank line 132 for delivery back to tank 106. At the second actuated position 168 of the second valve 110, pressurized fluid is supplied from the second bridge line 172 through the second valve 108 and is directed through the tilt cap-end line 178 to the cap-ends of the tilt cylinders 35. Additionally, at such second actuated position, return fluid flows from the rod-ends of the tilt cylinders 35 through the tilt rod-end line 176 back to the second valve 110, where the return fluid is then directed to the second return line 180 for delivery back to tank 106.

Referring still to FIG. 4, the third valve 112 is configured as a pilot-actuated, three position valve (e.g., a neutral position 182, a first actuated position 184, and a second actuated position 186). As indicated above, at the neutral position 182, the third valve 112 allows pressurized fluid to pass there-through for return back to tank 106 via the valve outlet line 130 and tank line 132. As shown in FIG. 4, in addition to the inlet port associated with the open-center configuration, the third valve 112 also includes an inlet port 188 fluidly coupled to the third valve supply line 128 via a third bridge line 190. The third bridge line 190 provides a fluid connection directly between the third valve supply line 128 and the inlet port 188 of the third valve 112 and incorporates a check valve 192 therewith to prevent back-flow.

At the first actuated position 184 of the third valve 112, pressurized fluid is supplied from the third bridge line 190 through the third valve 112 and is then directed through a first auxiliary line 194 to a first auxiliary coupler 114 for supply to the associated auxiliary component (e.g., actuator 120). Additionally, at such first actuated position, return fluid flows from the associated auxiliary component 120 (e.g., via a second auxiliary coupler 118) through a second auxiliary line 196 back to the third valve 112, where the return fluid is then directed to a third return line 198 that fluidly couples to the main return or tank line 132 for delivery back to tank 106. At the second actuated position 188 of the third valve 112, pressurized fluid is supplied from the third bridge line 190 through the third valve 112 and is directed through the second auxiliary line 196 to the second auxiliary coupler 118 for supply to the associated auxiliary component 120. Additionally, at such second actuated position, return fluid flows from the associated auxiliary component 120 (e.g., via the first auxiliary coupler 114) through the first auxiliary line 194 back to the third valve 112, where the return fluid is then directed to the third return line 198 for delivery back to tank 106.

Moreover, as shown in FIG. 4, the valve assembly 102 incorporates a bypass line 200 providing a separate passage that allows pressurized fluid to “bypass” or be diverted around the second valve 110 for delivery to the third valve 112. In other words, the bypass line 200 provides a parallel path for the pressurized fluid flowing from the first valve 108 through the second valve supply line 126. As shown in the illustrated embodiment, a first end 200A of the bypass line 200 is fluidly coupled to the second bridge line 172 at a location upstream of the associated check valve 174 and a second end 200B of the bypass line 200 is fluidly coupled to the third bridge line 190 at a location downstream of the associated check valve 192. As such, pressurized fluid flowing from the first valve 108 (e.g., via the second supply line 126) can be diverted through the bypass line 200 to the downstream third valve 112 without passing through the second valve 110, which allows for operability of auxiliary functions despite simultaneous operation of the tilt cylinders 35. For instance, the bypass line 200 may generally provide an alternative path for pressurized fluid to be directed to the third valve 112 anytime the second valve 110 is being actuated to control the operation of the tilt cylinders 35 and may provide the only path for pressurized fluid to be supplied to the third valve 112 when the second valve 110 is fully actuated to either actuated position 166, 168 (e.g., for full dump or full curl). It should be appreciated that, although the first end 200A of the bypass line 200 is shown as being fluidly coupled to the second bridge line 172 (e.g., at a location upstream of the check valve 174), the first end 200A of the bypass line 200 may, instead, be directly fluidly coupled to the second supply line 126 (e.g., at a location upstream of the location at which the second bridge line 172 connects to the second supply line 126).

As shown in the illustrated embodiment, the bypass line 200 incorporates both a check valve 202 and a restriction orifice or throttle 204. As should be readily appreciated, the check valve 202 allows fluid to flow through the bypass line 200 to the downstream third valve 112 while preventing back-flow in the opposite direction. Additionally, the throttle 204 is generally configured to reduce or restrict the amount of fluid flowing through the bypass line 200 as desired.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A hydraulic system for a work vehicle, the hydraulic system comprising:
a pump;
a valve assembly fluidly coupled to the pump, the valve assembly comprising:
a first supply line configured to receive pressurized hydraulic fluid from the pump;
a first valve fluidly coupled to the first supply line and being configured to control operation of a first hydraulic component of the work vehicle, the first valve having an unactuated position at which the pressurized hydraulic fluid received from the first supply line passes through the first valve to a downstream second supply line;
a second valve fluidly coupled to the second supply line and being configured to control operation of a second hydraulic component of the work vehicle, the second valve having an unactuated position at which the pressurized hydraulic fluid received from the second supply line passes through the second valve to a downstream third supply line; and
a third valve fluidly coupled to the third supply line and being configured to control operation of a third hydraulic component of the work vehicle;
wherein:
the first valve is configured to regulate a supply of the pressurized hydraulic fluid to the first hydraulic component and to receive return fluid from the first hydraulic component, with the return fluid being supplied through the second supply line fluidly coupling the first valve to the second valve; and
a bypass line provides a path for the pressurized hydraulic fluid flowing through the second supply line to bypass the second valve and be diverted to the third valve;
the second valve includes an inlet port fluidly coupled to the second supply line via a second bridge line;
the third valve includes an inlet port fluidly coupled to the third supply line via a third bridge line; and
a check valve is provided in association with each of the second bridge line and the third bridge line;
a first end of the bypass line is connected to the second bridge line upstream of the check valve associated with the second bridge line; and
a second end of the bypass line is connected to the third bridge line downstream of the check valve associated with the third bridge line.

2. The hydraulic system of claim 1, further comprising a check valve provided in association with the bypass line.

3. The hydraulic system of claim 2, further comprising a throttle provided in association within the bypass line.

4. The hydraulic system of claim 1, wherein the second valve has first and second actuated positions at which return fluid received from the second hydraulic component is discharged to tank.

5. The hydraulic system of claim 1, wherein the first hydraulic component comprises a lift cylinder of the work vehicle, the second hydraulic component comprises a tilt cylinder of the work vehicle, and the third hydraulic component comprises an auxiliary attachment of the work vehicle.

6. A work vehicle, comprising:
a lift assembly comprising at least one loader arm and an implement coupled to the at least one loader arm;
a lift cylinder configured to control movement of the at least one loader arm;
a tilt cylinder configured to control movement of the implement; and
a hydraulic system fluidly coupled to the lift and tilt cylinders, the hydraulic system comprising:
a pump;
a valve assembly fluidly coupled to the pump, the valve assembly comprising:
a first supply line configured to receive pressurized hydraulic fluid from the pump;
a first valve fluidly coupled to the first supply line and being configured to control operation of the lift cylinder, the first valve having an unactuated position at which the pressurized hydraulic fluid received from the first supply line passes through the first valve to a downstream second supply line;
a second valve fluidly coupled to the second supply line and being configured to control operation of the tilt cylinder, the second valve having an unactuated position at which the pressurized hydraulic fluid received from the second supply line passes through the second valve to a downstream third supply line; and
a third valve fluidly coupled to the third supply line and being configured to control operation of an auxiliary attachment of the work vehicle;
wherein:
the first valve is configured to regulate a supply of the pressurized hydraulic fluid to the lift cylinder and to receive return fluid from the lift cylinder, with the return fluid being supplied through the second supply line fluidly coupling the first valve to the second valve; and
a bypass line is fluidly coupled to the second supply line to provide a path for the pressurized hydraulic fluid flowing through the second supply line to bypass the second valve and be diverted to the third valve.

7. The work vehicle of claim 6, further comprising a check valve provided in association with the bypass line.

8. The work vehicle of claim 7, further comprising a throttle provided in association within the bypass line.

9. The work vehicle of claim 6, wherein:
the second valve includes an inlet port fluidly coupled to the second supply line via a second bridge line;
the third valve includes an inlet port fluidly coupled to the third supply line via a third bridge line; and
the bypass line fluidly connects the second bridge line to the third bridge line.

10. The work vehicle of claim 9, wherein:
a check valve is provided in association with each of the second bridge line and the third bridge line;
a first end of the bypass line is connected to the second bridge line upstream of the check valve associated with the second bridge line; and
a second end of the bypass line is connected to the third bridge line downstream of the check valve associated with the third bridge line.

11. The hydraulic system of claim 6, wherein the second valve has first and second actuated positions at which return fluid received from the second hydraulic component is discharged to tank.
